(19) United States
(12) Patent Application Publication
(10) Pub. No.: US 2026/0178910 A1
(43) Pub. Date: Jun. 25, 2026

(54) Optimal Unbiased Randomizers for Regression with Label Differential Privacy

(71) Applicant: Google LLC, Mountain View, CA (US)

(72) Inventors: Ashwinkumar Badanidiyuru Varadaraja, Los Altos, CA (US); Badih Ghazi, Cupertino, CA (US); Pritish Kamath, Mountain View, CA (US); Shanmugasundaram Ravikumar, Piedmont, CA (US); Ethan Jacob Leeman, Arlington, MA (US); Pasin Manurangsi, Bangkok (TH); Avinash Vaidyanathan Varadarajan, Los Altos, CA (US); Chiyuan Zhang, Mountain View, CA (US)

(21) Appl. No.: 18/842,469

(22) PCT Filed: Nov. 28, 2023
(86) PCT No.: PCT/US2023/081308

§ 371 Date: Aug. 29, 2024

Related U.S. Application Data
(60) Provisional application No. 63/545,380, filed on Oct. 24, 2023.

(51) Int. Cl. G06N 3/084; G06F 21/62; G06N 3/09

(52) U.S. Cl. CPC G06N 3/084; G06F 21/6254; G06N 3/09

(57) ABSTRACT

Aspects of the disclosure are directed to generating label randomizers for training regression models constrained by label differential privacy. The label randomizers can leverage trade-offs between bias and variance based on a privately estimated prior distribution over the labels. The label randomizers can achieve state-of-the-art privacy-utility trade-offs on several datasets, highlighting the importance of reducing bias when training neural networks with label differential privacy.

### CROSS-REFERENCE TO RELATED APPLICATIONS

The present application claims the benefit of the filing date of U.S. Provisional Application No. 63/545,380, filed Oct. 24, 2023, entitled Optimal Unbiased Randomizers for Regression with Label Differential Privacy, the disclosure of which is hereby incorporated herein by reference.

### BACKGROUND

Differential privacy has gained significant importance in recent years as a metric for quantifying the disclosure of user information through machine learning models. Differential privacy can guarantee that the model generated by the training process remains statistically indistinguishable, even if the data contributed by any individual user to the training dataset is modified arbitrarily.

For a training example, the training features may be accessible while the training label is kept private. For example, within the context of digital content management, e.g., advertising, conversion models are trained that aim to predict whether a digital content interaction, e.g., clicking an advertisement for an item on a publisher website, will result in a conversion, e.g., a purchase of the advertised item. In training the conversion model, the conversion labels, which indicate whether a purchase was completed or not, may not be known by the publisher website and may span multiple websites. This is known as label differential privacy.

For training the conversion model with regression objectives, such as squared loss or Poisson log loss, a feature-oblivious setting may be utilized to satisfy label differential privacy. The feature-oblivious setting includes a features party that has access to the features and a labels party that has access to the labels. The labels party can apply a differential privacy mechanism with respect to the labels to produce a message that the labels party sends to the features party. In particular, the labels party can estimate a prior over the labels and generate a randomizer optimizing noisy label loss with respect to this prior, and then apply this randomizer on the true labels to generate noisy labels, which are then sent in the message to the features party. The features party then uses the features along with the noisy labels in the message to train the conversion model. However, generating a randomizer in this manner does not account for bias, which can lead to lower performance when training the conversion model.

### BRIEF SUMMARY

Aspects of the disclosure are directed to generating label randomizers for training regression models constrained by label differential privacy. The label randomizers can leverage trade-offs between bias and variance based on a privately estimated prior distribution over the labels. The label randomizers can achieve state-of-the-art privacy-utility trade-offs on several datasets, highlighting the importance of reducing bias when training neural networks with label differential privacy. For instance, the trained regression models can achieve state-of-the-art or improved performance, e.g., accuracy, utility, and/or quality, with increased privacy, e.g., lower privacy parameters.

An aspect of the disclosure provides for a method for training a machine learning model with differentially private labels including: receiving, by one or more processors, a prior associated with a plurality of input labels and a sequence of potential output labels; generating, by the one or more processors, a differential privacy randomizer based on the prior and the sequence using an objective function constrained to reduce noisy label loss in an unbiased manner; randomizing, by the one or more processors, the plurality of input labels using the differential privacy randomizer to generate a plurality of randomized labels; and training, by the one or more processors, the machine learning model with the randomized labels. Another aspect of the disclosure provides for a system including: one or more processors; and one or more storage devices coupled to the one or more processors and storing instructions that, when executed by the one or more processors, cause the one or more processors to perform operations for the method for training the machine learning model with differentially private labels. Yet another aspect of the disclosure provides for a non-transitory computer readable medium for storing instructions that, when executed by one or more processors, cause the one or more processors to perform operations for the method for training the machine learning model with differentially private labels.

In an example, the differential privacy randomizer is a staircase mechanism. In another example, the staircase mechanism has up to twice as many output labels as the number of input labels.

In yet another example, reducing noisy label loss in an unbiased manner includes minimizing variance while ensuring zero bias. In yet another example, the objective function is further constrained with a non-negativity constraint, a normalization constraint, and a differential privacy constraint.

In yet another example, the sequence of potential output labels includes, as respective endpoints, a minimum and a maximum of possible outputs of an unbiased randomizer with bounded support. In yet another example, the unbiased randomizer with bounded support is configured to map inputs to a unique set of values with debiased randomized response. In yet another example, the sequence of potential output labels comprises a grid of evenly spaced output labels along an interval between the minimum and maximum.

In yet another example, the method further includes determining, by the one or more processors, the prior associated with the plurality of input labels using a Laplace mechanism. In yet another example, the Laplace mechanism includes constructing a histogram over the plurality of input labels and adding Laplace noise to each entry of the histogram.

In yet another example, the machine learning model is a regression model.

### BRIEF DESCRIPTION OF THE DRAWINGS

FIG. 1 depicts a block diagram of an example unbiased differential privacy randomizer according to aspects of the disclosure.

FIG. 2 depicts a block diagram of an example differentially private training system according to aspects of the disclosure.

FIG. 3 depicts example graphs of a prior distribution over a set of input labels using and a corresponding unbiased randomizer for a fine-grained set of potential output labels according to aspects of the disclosure.

FIG. 4 depicts a block diagram of an example environment for implementing a differentially private training system according to aspects of the disclosure.

FIG. 5 depicts a block diagram illustrating one or more example machine learning model architectures according to aspects of the disclosure.

FIG. 6 depicts a flow diagram of an example process for training one or more machine learning models using differentially private labels, where the prior distribution over the inputs labels is known according to aspects of the disclosure.

FIG. 7 depicts a flow diagram of an example process for training one or more machine learning models using differentially private labels, where the prior distribution over the inputs labels is unknown according to aspects of the disclosure.

FIG. 8 depicts example graphs for various label randomizers for a set privacy parameter according to aspects of the disclosure.

FIG. 9 depicts example graphs comparing the noisy label loss on the training set and the mean squared error on the test set for the randomizers considered on the Criteo Search dataset according to aspects of the disclosure.

FIG. 10 depicts an example graph comparing the mean squared error on the test set for the randomizers considered on the US Census dataset according to aspects of the disclosure.

FIG. 11 depicts an example graph comparing relative Poisson loss on the test set for the randomizers considered on the App Ads Conversion Count dataset according to aspects of the disclosure.

### DETAILED DESCRIPTION

The technology relates generally to an approach for generating label randomizers with bias limiting constraints for training machine learning models with differentially private labels. The trained models can have state-of-the-art or improved performance, even with higher noisy label loss. As an example, the labels can be conversion labels, which indicate whether an action, e.g., a purchase of an item, was completed or not in response to interacting with digital content, e.g., clicking on an advertisement for the item. The machine learning model can be a regression model, such as a neural network, implementing squared loss or Poisson log loss objectives.

The approach includes generating or receiving a prior over a plurality of discretized input labels and generating or receiving a sequence of potential output labels. The prior over the plurality of input labels can be determined using a Laplace mechanism, such as by constructing a histogram over the plurality of input labels and adding Laplace noise to each entry of the histogram. The sequence of potential output labels can be determined using an unbiased randomizer with bounded support, e.g., the outputs should be within a predetermined region. For example, the sequence of potential output labels can include a minimum and a maximum of possible outputs of the randomizer as respective endpoints, with a grid of evenly spaced output labels along an interval between the minimum and maximum. The unbiased randomizer with bounded support can be configured to map inputs to a unique set of values using debiased randomized response.

The approach further includes generating a differential privacy randomizer based on the prior and the sequence using an objective function constrained to reduce noisy label loss in an unbiased manner. For example, the differential privacy randomizer can have at most twice as many output labels as the number of input labels. For example, the objective function can be constrained to minimize variance while ensuring zero bias. The objective function can further be constrained with a non-negativity constraint, a normalization constraint, and a differential privacy constraint. The non-negativity constraint and normalization constraint arise because the output of the randomizer on any input has a probability distribution, so each probability value should be non-negative and the probability values should sum to 1. The differential privacy constraint arises to ensure the generated randomizer satisfies label differential privacy according to a differential privacy parameter, e.g., the labels remain statistically indistinguishable.

The approach additionally includes randomizing the plurality of input labels using the differential privacy randomizer to generate a plurality of randomized labels and training a machine learning model with the randomized labels, such as via supervised learning.

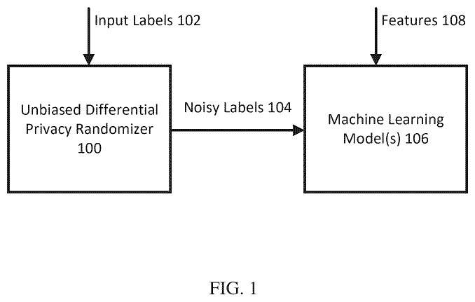

FIG. 1 depicts a block diagram of an example unbiased differential privacy randomizer 100. The unbiased differential privacy randomizer 100 can receive input labels 102 and randomize the input labels 102 to generate noisy labels 104. One or more machine learning models 106 can receive the noisy labels 104, along with features 108, for training the machine learning models 106. To be unbiased, for each input label 102 received by the randomizer 100, a noisy label 104 output by the randomizer is on average equal to the input label 102. The noisy labels 104 and features 108 can be utilized to train the machine learning models 106 through supervised learning, as an example.

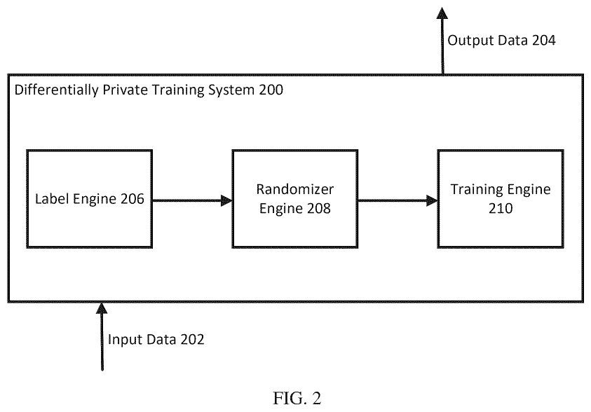

FIG. 2 depicts a block diagram of an example differentially private training system 200 for training machine learning models with differentially private labels in an unbiased manner. The differentially private training system 200 can be implemented on one or more computing devices in one or more locations.

The differentially private training system 200 can be configured to receive input data 202. For example, the differentially private training system 200 can receive the input data 202 as part of a call to an application programming interface (API) exposing the differentially private training system 200 to one or more computing devices. The input data 202 can also be provided to the differentially private training system 200 through a storage medium, such as remote storage connected to the one or more computing devices over a network. The input data 202 can further be provided as input through a user interface on a client computing device coupled to the differentially private training system 200.

The input data 202 can include training data for training the machine learning models. The training data can include examples of features and labels associated with any machine learning task, such as predicting conversions for digital content. The training data can be split into a training set, a validation set, and/or a testing set. An example training/validation/testing split can be an 80/10/10 split, although any other split may be possible.

The labels can include input labels and potential output labels for generating an unbiased randomizer for label differential privacy. The unbiased randomizers can randomize labels in order to satisfy differential privacy constraints when training the machine learning models. The input data 202 can further include one or more privacy parameters ε to indicate the scale of differential privacy applied to the labels. For example, ε-differential privacy is satisfied when Pr [A(X)∈S]≤e^{ε}·Pr [A(X′)εS] for any two adjacent input datasets X and X′ and any subset S of outputs of a randomized algorithm A. In the context of supervised learning, the randomized algorithm can produce a model as its output while the labeled training set can serve as the input. Two input datasets are considered adjacent if they differ on the label of a single training example.

As another example, the label differential privacy can be feature-oblivious label differential privacy. This can include a features party and a labels party, where the features party has a sequence

$${( {x}_{i} )}_{i = 1}^{n}$$

of all feature vectors across the n users and the labels party has the sequence

$${( {y}_{i} )}_{i = 1}^{n}$$

of the corresponding labels. The labels party can send a message M (y₁, . . . , yₙ) to the features party. The message can be randomized or not randomized. Based on its input and the received message, the features party can generate a machine learning model as its output. The output of the features party can satisfy feature-oblivious differential privacy if the message M satisfies differential privacy where two inputs are considered adjacent if they differ on a single yᵢ.

From the input data 202, the differentially private training system 200 can be configured to output one or more results generated as output data 204. The output data 204 can include an unbiased randomizer associated with a machine learning task and/or a machine learning model trained with labels randomized by the unbiased randomizer. As an example, the differentially private training system 200 can be configured to send the output data 204 for display on a client or user display. As another example, the differentially private training system 200 can be configured to provide the output data 204 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The differentially private training system 200 can further be configured to forward the output data 204 to one or more other devices configured for translating the output data into an executable program written in a computer programming language. The differentially private training system 200 can also be configured to send the output data 204 to a storage device for storage and later retrieval.

The differentially private training system can include a label engine 206, a randomizer engine 208, and a training engine 210. The label engine 206, randomizer engine 208, and training engine 212 can be implemented as one or more computer programs, specially configured electronic circuitry, or any combination thereof.

The label engine 206 can be configured to generate a prior over a plurality of input labels and/or generate a sequence of potential output labels. The prior and the sequence can be generated from the input labels, which are included in the input data 202.

For generating the prior, the label engine 206 can be configured to use a Laplace mechanism to privately estimate the prior P. For example, given n samples drawing from P, the Laplace mechanism

$${M}_{ε}^{L a p}$$

constructs a histogram over input labels Y and adds Laplace noise with scale 2/ε to each entry of the histogram. The Laplace mechanism

$${M}_{ε}^{L a p}$$

can further clip the entries to ensure the entries are non-negative and/or normalize the entries.

For generating the sequence of potential output labels, the label engine 206 can be configured to determine, such as through a linear programming solver, a set of output values Ŷ that can guarantee feasibility of the linear programming when generating the label randomizer. For example, the label engine 206 can set Ŷ to be a grid. The label engine 206 can compute the endpoints of the grid using an unbiased randomizer with bounded support, such as a debiased randomized response, on the set of input labels.

The unbiased randomizer with bounded support can map the input labels to a unique set of values where, under randomized response, the randomizer is unbiased. For example, the unbiased randomizer with bounded support can perform randomized response on

$$Φ ( y ) = \frac{( ( {e}^{ε} + \vert Y \vert - 1 ) y - {\sum }_{{y}^{′} ∈ Y} {y}^{′} )}{( {e}^{ε} - 1 )} .$$

The unbiased randomizer with bounded support can, from input y, sample ŷ˜Ŷ where the random variable Ŷ is distributed as:

$$PrP r [ \hat{Y} = \hat{y} ] = \{ \frac{{e}^{ε}}{{e}^{ε} + \vert Y \vert - 1} if \hat{y} = Φ ( y ) \frac{1}{{e}^{ε} + \vert Y \vert - 1} otherwise .$$

The endpoints of the grid can be the minimum and maximum among possible outputs of the unbiased randomizer with bounded support. With the endpoints, the label engine 206 can generate the remainder of the grid by evenly spacing output labels along an interval, where the number of output labels generated is as large as possible while maintaining that the linear programming solver terminates in a reasonable amount of time. A reasonable amount of time can vary from a few seconds to a few hours based on the number of input and output labels considered as well as the choice of linear programming solver.

For larger privacy parameter values, an unbiased randomizer can approach the debiased randomized response on the entire set of labels. For smaller privacy parameter values, the unbiased randomizer can be supported on the labels of the debiased randomized response on the two label set of the minimum and the maximum label. Below is an example procedure for generating the sequence of potential output labels.

Parameters: Privacy parameter ε≥0.

Input: Set of input labels Y. Positive integer n≥2 representing the size of output |Ŷ|.

Output: Set of output values Ŷ that guarantees feasibility of linear programming.

$$L ← \frac{( ( {e}^{ε} + \vert Y \vert - 1 ) \cdot ( Y ) - {\sum }_{y ∈ Y} y )}{( {e}^{ε} - 1 )} ;$$

$$U ← \frac{( ( {e}^{ε} + \vert Y \vert - 1 ) \cdot ( Y ) - {\sum }_{y ∈ Y} y )}{( {e}^{ε} - 1 )} ;$$

$$Δ ← \frac{( U - L )}{( n - 1 )} ;$$

$$Return : \hat{Y} = ( L , L + Δ , L + 2 Δ , … , U - Δ , U ) .$$

The randomizer engine 208 can be configured to generate an unbiased, differential privacy randomizer based on the prior over the plurality of input labels and the sequence of potential output labels. The differential privacy randomizer can be a staircase mechanism having up to twice as many output labels as the number of the plurality of input labels. A staircase mechanism may refer to a randomizer having extremal properties. For example, the probabilities of any output of the randomizer given any input take the most extreme values possible while satisfying differential privacy. The randomizer engine 208 can generate the differential privacy randomizer using an objective function that reduces, e.g., minimizes, noisy label loss while being unbiased. Being unbiased refers to, for any input to the randomizer, an output of the randomizer is on average equal to the input. For example, a randomizer M that maps a label set Y⊆R to R can be unbiased if the randomizer satisfies E_{ŷ˜M(y)}ŷ=y for all input labels y∈Y. For instance, if an input y=1.0 and the randomizer output −1.0 with probability 0.25 and 2.0 with probability 0.75, then the average output value is −1.0×0.25+2.0×0.75=1, satisfying the unbiasedness constraint for input y. The randomizer engine 208 can use linear programming with an unbiasedness constraint to compute the unbiased randomizer that reduces noisy label loss. The randomizer engine 208 linear programming can further include a non-negativity constraint, a normalization constraint, and/or a differential privacy label constraint for computing the unbiased, differential privacy randomizer. The non-negativity constraint and normalization constraint arise because the output of the randomizer on any input has a probability distribution, so each probability value should be non-negative and the probability values should sum to 1. The differential privacy constraint arises to ensure the generated randomizer satisfies label differential privacy according to a differential privacy parameter, e.g., the labels remain statistically indistinguishable. Below is an example procedure for generating the unbiased, differential privacy randomizer.

Parameters: Privacy parameter ε≥0.

Input: Prior P over input labels Y, where P=(p_{y})_{y∈Y}; a finite sequence of potential output labels Ŷ, where Ŷ=(ŷᵢ)_{i∈x}.

Output: An ε-differential privacy label randomizer.

Solver the following linear programming in variables M=(M_{y→i})_{y∈Y,i∈I}:

$${min}_{M} {\sum }_{y ∈ Y} {p}_{y} ( {\sum }_{\hat{y} ∈ \hat{Y}} {M}_{y \to i} \cdot g ( {\hat{y}}_{i} , y ) ) , subject to :$$

$$[ Non - negativity ] ∀ y ∈ Y , i ∈ I : {M}_{y \to i} \geq 0 ;$$

$$[ Normalization ] ∀ y ∈ Y : {\sum }_{i ∈ I} {M}_{y \to i} = 1 ;$$

$$[ ε - Label Differential Privacy ] ∀ i ∈ I , ∀ y , {y}^{′} ∈ Y where$$

$$y \neq {y}^{′} : {M}_{{y}^{′} \to i} \leq {e}^{ε} \cdot {M}_{y \to i} ;$$

$$[ Unbiasedness ] ∀ y ∈ Y : {\sum }_{i ∈ I} {M}_{y \to i} \cdot {\hat{y}}_{i} = y .$$

Return: Label Randomizer M mapping Y to Ŷ given by Pr Pr [M(y)=ŷᵢ]=M_{y→i}.

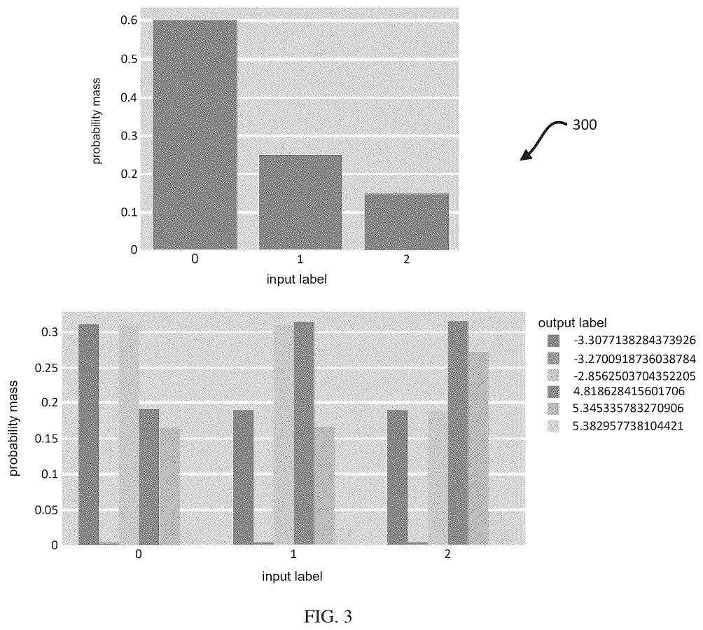

FIG. 3 depicts example graphs 300 of a prior P over Y={0,1,2} using the following example distribution table and a corresponding unbiased randomizer for a fine-grained Ŷ where ε=0.5.

| | 0 | 1 | 2 |
|---|---|---|---|
| A | 0.35 | 0.1 | 0.05 |
| B | 0.25 | 0.15 | 0.1 |

The generated randomizer is distinct from alternative randomizers like randomizer response or any additive noise mechanism. The generated randomizer surprisingly yields better trained models, despite the output labels being outside [0,2], which is the convex hull of Y. This may be attributed to the Bayes optimal predictor for this randomizer being f_{D}* since E[M(y)]=y for y∈Y.

Referring back to FIG. 2, the randomizer engine 208 can receive a known prior over the plurality of input labels as part of the input data 202 or the label engine 206 can generate a prior over the plurality of input labels. Below is an example procedure for generating the unbiased, differential privacy randomizer when the prior is unknown and generated from the label engine 206.

Parameters: Privacy parameters ε₁, ε₂≥0.

Input: Labels y₁, . . . , yₙ∈Y.

Output: ŷ₁, . . . , ŷₙ∈Ŷ.

$${P}^{′} ← {M}_{{ε}_{1}}^{L a p} ( {y}_{1} , … , {y}_{n} ) ;$$

$$\hat{Y} ← F e a s i bleOutputSe {t}_{{ε}_{1}} ( Y ) ;$$

$$M ← {ComputeOptUnbiasedRand}_{{ε}_{2}} ( {P}^{′} , \hat{Y} ) for i ∈ [ n ] do {\hat{y}}_{i} ← M ( {y}_{i} ) .$$

Return: (ŷ₁, . . . , ŷₙ).

The privacy parameters can be split into ε₁ and ε₂, where the label engine 206 uses ε₁ in the Laplace mechanism for generating an approximate prior distribution P′ and the randomizer engine 208 uses ε₂ to generate the unbiased, differential privacy randomizer based on the approximate prior distribution P′ and the sequence of potential output labels Ŷ.

The randomizer engine 208 can be further configured to randomize the plurality of input labels from the input data 202 into a plurality of randomized labels using the unbiased, differential privacy randomizer.

The training engine 210 can be configured to train one or more machine learning models with the randomized labels. The machine learning models can be trained according to a variety of different learning techniques. Learning techniques for training the machine learning models can include supervised learning, unsupervised learning, semi-supervised learning, and reinforcement learning techniques. For example, the training data can include multiple training examples that can be received as input by the machine learning models. The training examples can be labeled with a desired output for the model when processing the labeled training examples. The training examples can be labeled with the randomized labels. The randomized labels and the model output can be evaluated through a loss function to determine an error, which can be back propagated through the machine learning model to update weights for the model.

For example, a supervised learning technique can be applied to calculate an error between outputs, with a ground-truth label of a training example processed by the machine learning models. Any of a variety of loss or error functions appropriate for the type of the task the model is being trained for can be utilized, such as cross-entropy loss for classification tasks, or Poisson log loss or squared loss for regression tasks. The gradient of the error with respect to the different weights of the candidate model on candidate hardware can be calculated, for example using a backpropagation algorithm, and the weights for the model can be updated.

The training engine 210 can train the machine learning models until one or more stopping criteria are met, such as a number of iterations for training, a maximum period of time, a convergence, or when a minimum accuracy threshold is met.

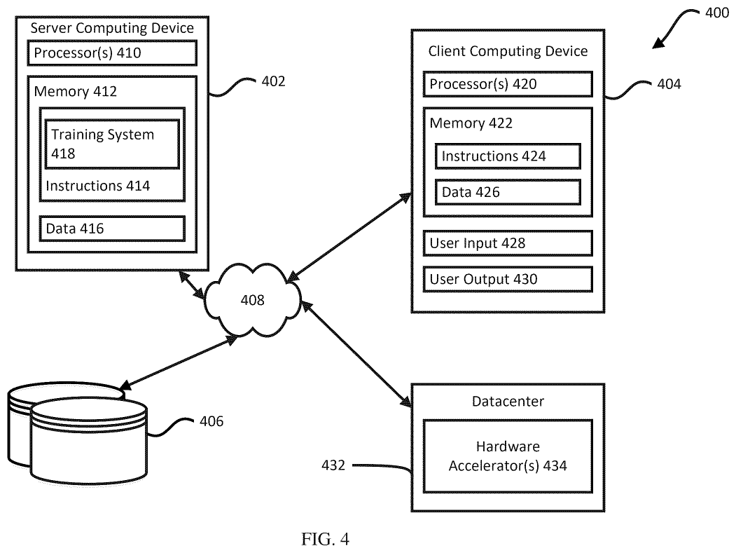

FIG. 4 depicts a block diagram of an example environment 400 for implementing a differentially private training system 418. The differentially private training system 418 can be implemented on one or more devices having one or more processors in one or more locations, such as in server computing device 402. Client computing device 404 and the server computing device 402 can be communicatively coupled to one or more storage devices 406 over a network 408. The storage devices 406 can be a combination of volatile and non-volatile memory and can be at the same or different physical locations than the computing devices 402, 404. For example, the storage devices 406 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 402 can include one or more processors 410 and memory 412. The memory 412 can store information accessible by the processors 410, including instructions 414 that can be executed by the processors 410. The memory 412 can also include data 416 that can be retrieved, manipulated, or stored by the processors 410. The memory 412 can be a type of transitory or non-transitory computer readable medium capable of storing information accessible by the processors 410, such as volatile and non-volatile memory. The processors 410 can include one or more central processing units (CPUs), graphic processing units (GPUs), field-programmable gate arrays (FPGAs), and/or application-specific integrated circuits (ASICs), such as tensor processing units (TPUs).

The instructions 414 can include one or more instructions that, when executed by the processors 410, cause the one or more processors 410 to perform actions defined by the instructions 414. The instructions 414 can be stored in object code format for direct processing by the processors 410, or in other formats including interpretable scripts or collections of independent source code modules that are interpreted on demand or compiled in advance. The instructions 414 can include instructions for implementing a differentially private training system 418, which can correspond to the differentially private training system 200 as depicted in FIG. 2. The differentially private training system 418 can be executed using the processors 410, and/or using other processors remotely located from the server computing device 402.

The data 416 can be retrieved, stored, or modified by the processors 410 in accordance with the instructions 414. The data 416 can be stored in computer registers, in a relational or non-relational database as a table having a plurality of different fields and records, or as JSON, YAML, proto, or XML documents. The data 416 can also be formatted in a computer-readable format such as, but not limited to, binary values, ASCII, or Unicode. Moreover, the data 416 can include information sufficient to identify relevant information, such as numbers, descriptive text, proprietary codes, pointers, references to data stored in other memories, including other network locations, or information that is used by a function to calculate relevant data.

The client computing device 404 can also be configured similarly to the server computing device 402, with one or more processors 420, memory 422, instructions 424, and data 426. The client computing device 404 can also include a user input 428 and a user output 430. The user input 428 can include any appropriate mechanism or technique for receiving input from a user, such as keyboard, mouse, mechanical actuators, soft actuators, touchscreens, microphones, and sensors.

The server computing device 402 can be configured to transmit data to the client computing device 404, and the client computing device 404 can be configured to display at least a portion of the received data on a display implemented as part of the user output 430. The user output 430 can also be used for displaying an interface between the client computing device 404 and the server computing device 402. The user output 430 can alternatively or additionally include one or more speakers, transducers or other audio outputs, a haptic interface or other tactile feedback that provides non-visual and non-audible information to the platform user of the client computing device 404.

Although FIG. 4 illustrates the processors 410, 420 and the memories 412, 422 as being within the respective computing devices 402, 404, components described herein can include multiple processors and memories that can operate in different physical locations and not within the same computing device. For example, some of the instructions 414, 424 and the data 416, 426 can be stored on a removable SD card and others within a read-only computer chip. Some or all of the instructions 414, 424 and data 416, 426 can be stored in a location physically remote from, yet still accessible by, the processors 410, 420. Similarly, the processors 410, 420 can include a collection of processors that can perform concurrent and/or sequential operation. The computing devices 402, 404 can each include one or more internal clocks providing timing information, which can be used for time measurement for operations and programs run by the computing devices 402, 404.

The server computing device 402 can be connected over the network 408 to a data center 432 housing any number of hardware accelerators 434. The data center 432 can be one of multiple data centers or other facilities in which various types of computing devices, such as hardware accelerators, are located. Computing resources housed in the data center 432 can be specified for deploying models, such as for conversion prediction, as described herein.

The server computing device 402 can be configured to receive requests to process data from the client computing device 404 on computing resources in the data center 432. For example, the environment 400 can be part of a computing platform configured to provide a variety of services to users, through various user interfaces and/or application programming interfaces (APIs) exposing the platform services. The variety of services can include predicting conversions from digital content interaction, e.g., whether a purchase of an item or service was completed or not in response to clicking on an advertisement associated with the item or service. The client computing device 404 can transmit input data as part of a query for a particular task. The differentially private training system 418 can receive the input data, and in response, generate output data including a response to the query for the particular task.

The server computing device 402 can maintain a variety of models in accordance with different constraints available at the data center 432. For example, the server computing device 402 can maintain different families for deploying models on various types of TPUs and/or GPUs housed in the data center 432 or otherwise available for processing.

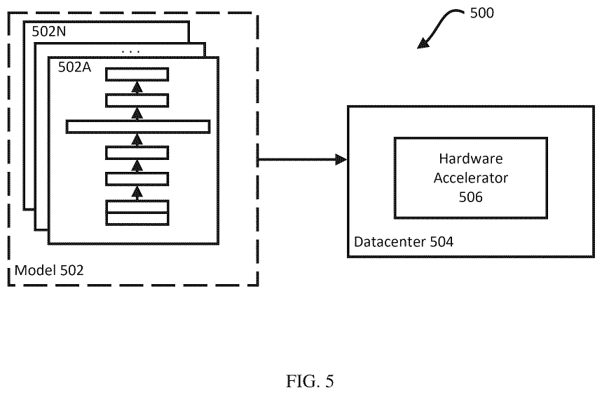

FIG. 5 depicts a block diagram 500 illustrating one or more machine learning model architectures 502, more specifically 502A-N for each architecture, for deployment in a datacenter 504 housing a hardware accelerator 506 on which the deployed machine learning models 502 will execute, such as for the variety of services as described herein. The hardware accelerator 506 can be any type of processor, such as a CPU, GPU, FPGA, or ASIC such as a TPU.

An architecture 502 of a machine learning model can refer to characteristics defining the model, such as characteristics of layers for the model, how the layers process input, or how the layers interact with one another. The architecture 502 of the machine learning model can also define types of operations performed within each layer. One or more machine learning model architectures 502 can be generated that can output results, such as for conversion prediction of digital content. Example model architectures 502 can correspond to regression models, such as neural networks.

Referring back to FIG. 4, the devices 402, 404 and the data center 432 can be capable of direct and indirect communication over the network 408. For example, using a network socket, the client computing device 404 can connect to a service operating in the data center 432 through an Internet protocol. The devices 402, 404 can set up listening sockets that may accept an initiating connection for sending and receiving information. The network 408 can include various configurations and protocols including the Internet, World Wide Web, intranets, virtual private networks, wide area networks, local networks, and private networks using communication protocols proprietary to one or more companies. The network 408 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 408, in addition or alternatively, can also support wired connections between the devices 402, 404 and the data center 432, including over various types of Ethernet connection.

Although a single server computing device 402, client computing device 404, and data center 432 are shown in FIG. 4, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing machine learning models, or any combination thereof.

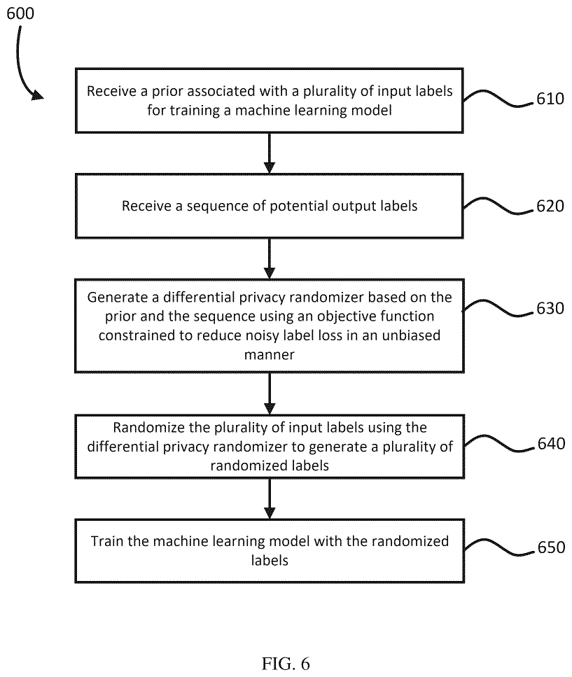

FIG. 6 depicts a flow diagram of an example process 600 for training one or more machine learning models using differentially private labels, where the prior distribution over the inputs labels is known. The example process can be performed on a system of one or more processors in one or more locations, such as the differentially private training system 200 as depicted in FIG. 2.

As shown in block 610, the differentially private training system 200 can be configured to receive a prior associated with a plurality of input labels for training a machine learning model. The prior can be a prior distribution over the plurality of input labels. The plurality of input labels can be conversion labels indicating whether an action occurred or not in response to an interaction with digital content. For example, the conversion labels can indicate whether an item was purchased in response to clicking on an advertisement for the item. The machine learning model can be a regression model for implementing squared loss or Poisson log loss objectives, such as a neural network.

As shown in block 620, the differentially private training system 200 can receive a sequence of potential output labels. The sequence of potential output labels can include a minimum and maximum of possible outputs of an unbiased randomizer with bounded support. The unbiased randomizer with bounded support can be a debiased randomized response configured to map inputs to a unique set of values. The minimum and maximum of possible outputs can be endpoints of a grid of evenly spaced output labels along an interval between the minimum and maximum.

As shown in block 630, the differentially private training system 200 can generate a differential privacy randomizer based on the prior and the sequence using an objective function constrained to reduce noisy label loss in an unbiased manner. The differential privacy randomizer can be a staircase mechanism and can have up to twice as many output labels as the number of the plurality of input labels. Reducing the noisy label loss in an unbiased manner can reduce, e.g., minimize, variance while ensuring zero bias. The objective function can further be constrained with a non-negativity constraint, a normalization constraint, and/or a differential privacy constraint.

As shown in block 640, the differentially private training system 200 can randomize the plurality of input labels using the differential privacy randomizer to generate a respective plurality of randomized labels.

As shown in block 650, the differentially private training system 200 can train the machine learning model with the randomized labels. The machine learning model can be trained according to a variety of different learning techniques, such as supervised learning, unsupervised learning, semi-supervised learning, or reinforcement learning. The differentially private training system 200 can output the trained machine learning model. For example, the trained machine learning model can be deployed to predict conversions based on data associated with digital content interaction.

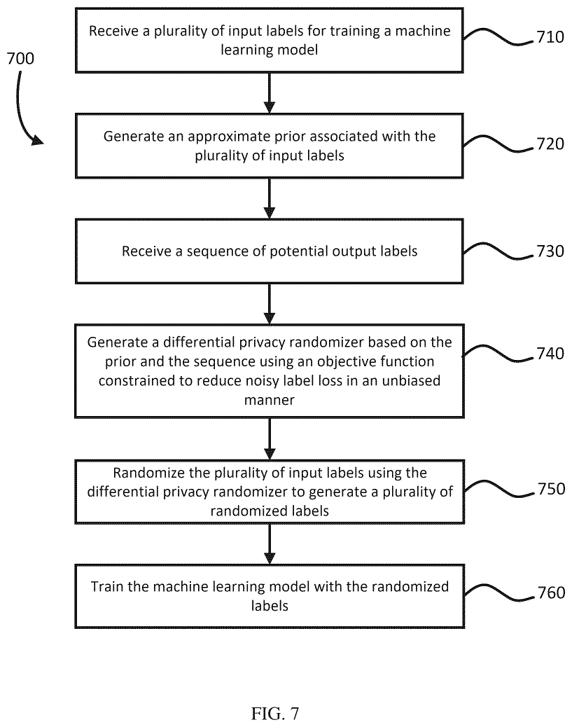

FIG. 7 depicts a flow diagram of an example process 700 for training one or more machine learning models using differentially private labels, where the prior distribution over the inputs labels is unknown. The example process can be performed on a system of one or more processors in one or more locations, such as the differentially private training system 200 as depicted in FIG. 2.

As shown in block 710, the differentially private training system 200 can be configured to receive a plurality of input labels for training a machine learning model. The plurality of input labels can be conversion labels indicating whether an action occurred or not in response to an interaction with digital content. For example, the conversion labels can indicate whether an item was purchased in response to clicking on an advertisement for the item. The machine learning model can be a regression model for implementing squared loss or Poisson log loss objectives, such as a neural network.

As shown in block 720, the differentially private training system 200 can be configured to generate an approximate prior associated with the plurality of input labels. The approximate prior can be an approximate prior distribution over the plurality of input labels. The differentially private training system 200 can determine the approximate prior using a Laplace mechanism, such as by constructing a histogram over the plurality of input labels and adding Laplace noise to each entry of the histogram. The entries can also be clipped to ensure the entries are non-negative and/or normalized.

Blocks 730, 740, 750, and 760 can respectively correspond to blocks 620, 630, 640, and 650 as depicted in FIG. 6. As shown in block 730, the differentially private training system 200 can receive a sequence of potential output labels. As shown in block 740, the differentially private training system 200 can generate a differential privacy randomizer based on the approximate prior and the sequence using an objective function constrained to reduce noisy label loss in an unbiased manner. As shown in block 750, the differentially private training system 200 can randomize the plurality of input labels using the differential privacy randomizer to generate a respective plurality of randomized labels. As shown in block 760, the differentially private training system 200 can train the machine learning model with the randomized labels. The differentially private training system 200 can output the trained machine learning model.

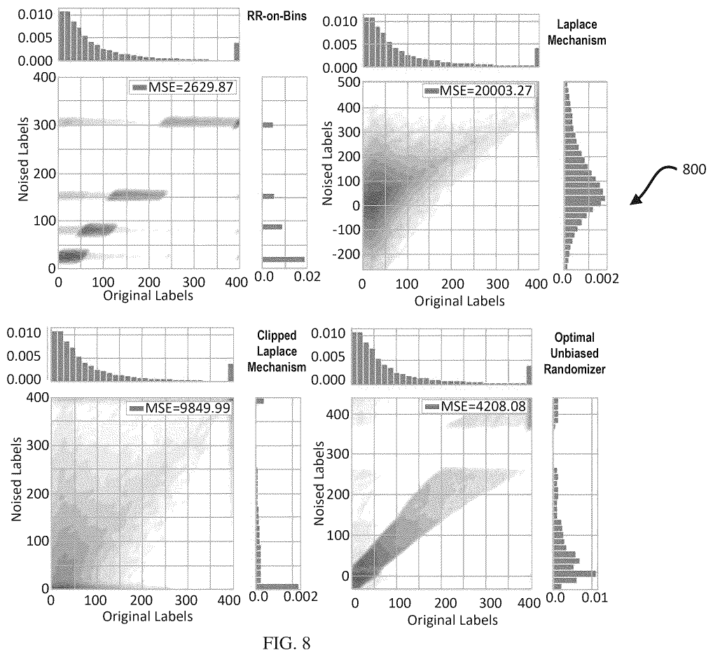

As illustrated in FIGS. 8-11, a differentially private training system as disclosed herein can achieve or improve upon alternative approaches for training machine learning models for various tasks, even with higher noisy label loss.

The randomizer as disclosed herein was evaluated on three datasets and compared with alternatives including Laplace mechanism, additive staircase mechanism, and randomized response on bins (RR-on-bins) method. The Laplace mechanism and the additive staircase mechanism both have a discrete and a continuous variant. For randomized response on bins, continuous variants are used for real-valued labels and discrete variants are used for integer-valued labels. The three datasets include a Criteo Sponsored Search Conversion Log dataset, a US Census dataset, and an App Ads Conversion Count dataset.

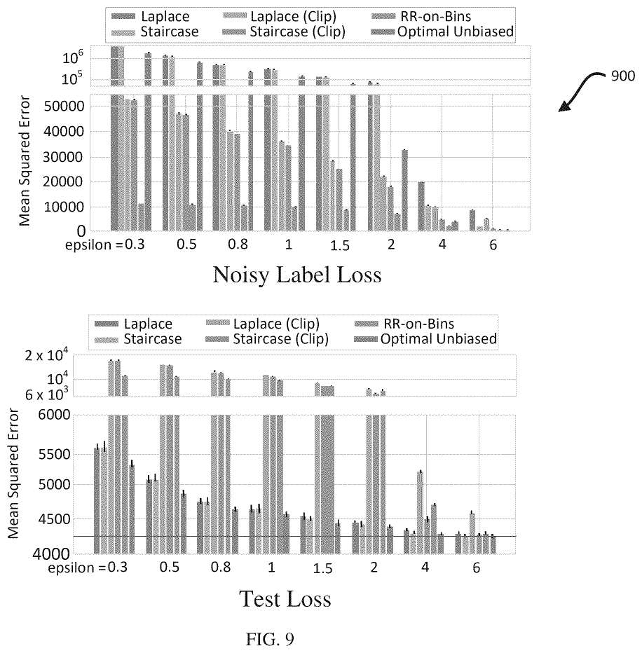

The Criteo Sponsored Search Conversion Log dataset is a collection of 15,995,634 data points derived from a sample of 90-day logs of live traffic from Criteo Predictive Search (CPS). Each example contains information of a user action, e.g., a click on an advertisement, and a subsequent conversion, e.g., purchase of the related product, within a 30-day attribution window. FIG. 8 depicts graphical examples 800 of the various label randomizers for ε=4. The 2D density plot contours are generated in log scale using Gaussian kernel density estimates. The legends show the mean squared error (MSE) between original labels and the differentially private randomized labels. The optimal RR-on-Bins randomizer maps the input values to one of 4 distinct values. On the other hand, for the optimal unbiased randomizer, the joint distribution of the sensitive labels and randomized labels maintains an overall concentration along the diagonal. The joint distribution for the Laplace mechanism is spread out. FIG. 9 depicts example graphs 900 comparing the noisy label loss on the training set and the mean squared error on the test set for the randomizers considered on the Criteo Search dataset. The optimal unbiased randomizer achieves the smallest test mean squared error across a wide range of ε values.

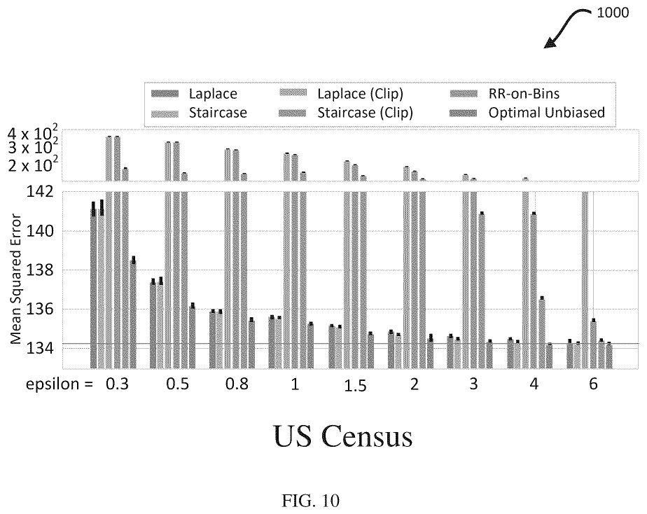

The US Census dataset is a 1940 Census dataset containing 131,903,909 examples. Label differential privacy methods are evaluated by learning to predict the number of weeks each respondent worked during the previous year. FIG. 10 depicts an example graph 1000 comparing the mean squared error on the test set for the randomizers considered. The optimal unbiased randomizer achieves the smallest test mean squared error across a wide range of ε values.

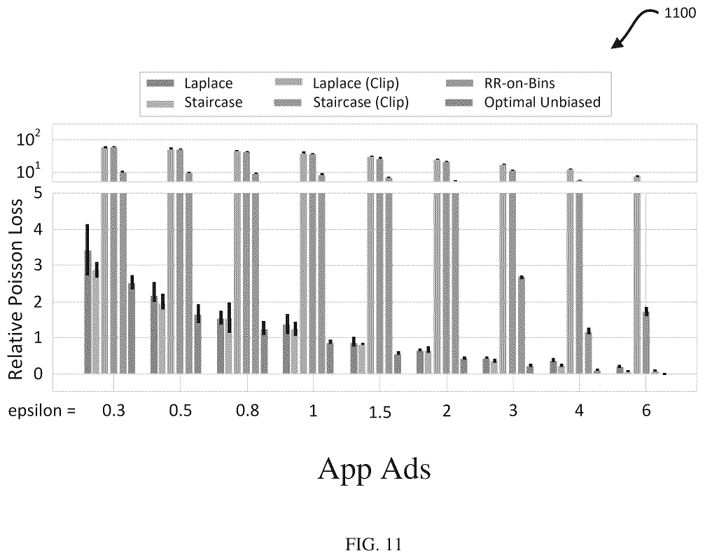

The App Ads Conversion Count dataset is a conversion count prediction dataset collected from a commercial mobile app store. The examples in this dataset contains ad clicks and the task is to predict the number of post-click conversion events in the app after a user installs the app within a certain time window. FIG. 11 depicts an example graph 1100 comparing relative Poisson loss on the test set for the randomizers considered. The optimal unbiased randomizer outperforms the others across a wide range of ε values, even with a standard error increase at lower ε values.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” or “data processing system” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for training a machine learning model with differentially private labels comprising:
receiving, by one or more processors, a prior associated with a plurality of input labels and a sequence of potential output labels;
generating, by the one or more processors, a differential privacy randomizer based on the prior and the sequence using an objective function constrained to reduce noisy label loss in an unbiased manner;
randomizing, by the one or more processors, the plurality of input labels using the differential privacy randomizer to generate a plurality of randomized labels; and
training, by the one or more processors, the machine learning model with the randomized labels.

2. The method of claim 1, wherein the differential privacy randomizer is a staircase mechanism.

3. The method of claim 2, wherein the staircase mechanism has up to twice as many output labels as the number of the plurality of input labels.

4. The method of claim 1, wherein reducing noisy label loss in an unbiased manner comprises minimizing variance with zero bias.

5. The method of claim 1, wherein the objective function is further constrained with a non-negativity constraint, a normalization constraint, and a differential privacy constraint.

6. The method of claim 1, wherein the sequence of potential output labels comprises, as respective endpoints, a minimum and a maximum of possible outputs of an unbiased randomizer with bounded support.

7. The method of claim 6, wherein the unbiased randomizer with bounded support is configured to map inputs to a unique set of values with debiased randomized response.

8. The method of claim 6, wherein the sequence of potential output labels comprises a grid of evenly spaced output labels along an interval between the minimum and maximum.

9. The method of claim 1, further comprising determining, by the one or more processors, the prior associated with the plurality of input labels using a Laplace mechanism.

10. The method of claim 9, wherein the Laplace mechanism comprises constructing a histogram over the plurality of input labels and adding Laplace noise to each entry of the histogram.

11. A system comprising:
one or more processors; and
one or more storage devices coupled to the one or more processors and storing instructions that, when executed by the one or more processors, cause the one or more processors to perform operations for training a machine learning model with differentially private labels, the operations comprising:
receiving a prior associated with a plurality of input labels and a sequence of potential output labels;
generating a differential privacy randomizer based on the prior and the sequence using an objective function constrained to reduce noisy label loss in an unbiased manner;
randomizing the plurality of input labels using the differential privacy randomizer to generate a plurality of randomized labels; and
training the machine learning model with the randomized labels.

12. The system of claim 11, wherein the differential privacy randomizer is a staircase mechanism having up to twice as many output labels as the number of the plurality of input labels.

13. The system of claim 11, wherein reducing noisy label loss in an unbiased manner comprises minimizing variance with zero bias.

14. The system of claim 11, wherein the objective function is further constrained with a non-negativity constraint, a normalization constraint, and a differential privacy constraint.

15. The system of claim 11, wherein the sequence of potential output labels comprises, as respective endpoints, a minimum and a maximum of possible outputs of an unbiased randomizer with bounded support.

16. The system of claim 15, wherein the unbiased randomizer with bounded support is configured to map inputs to a unique set of values with debiased randomized response.

17. The system of claim 15, wherein the sequence of potential output labels comprises a grid of evenly spaced output labels along an interval between the minimum and maximum.

18. The system of claim 11, wherein the operations further comprise determining the prior associated with the plurality of input labels using a Laplace mechanism.

19. The system of claim 18, wherein the Laplace mechanism comprises constructing a histogram over the plurality of input labels and adding Laplace noise to each entry of the histogram.

20. A non-transitory computer readable medium for storing instructions that, when executed by one or more processors, cause the one or more processors to perform operations for training a machine learning model with differentially private labels, the operations comprising:
receiving a prior associated with a plurality of input labels and a sequence of potential output labels;
generating a differential privacy randomizer based on the prior and the sequence using an objective function constrained to reduce noisy label loss in an unbiased manner;
randomizing the plurality of input labels using the differential privacy randomizer to generate a plurality of randomized labels; and
training the machine learning model with the randomized labels.
